(19) United States
(12) Patent Application Publication
(10) Pub. No.: US 2014/0192524 A1
(43) Pub. Date: Jul. 10, 2014

(54) INTEGRATED OPTIC LAMP

(71) Applicants: Ajaypal S. Naruka, Twinsburg, OH (US); Mark J. Duda, Twinsburg, OH (US); Adam Webster, Shaker Heights, OH (US)

(72) Inventors: Ajaypal S. Naruka, Twinsburg, OH (US); Mark J. Duda, Twinsburg, OH (US); Adam Webster, Shaker Heights, OH (US)

(21) Appl. No.: 13/735,275

(22) Filed: Jan. 7, 2013

(51) Int. Cl. F21V 7/00; F21V 17/04; F21V 19/02

(52) U.S. Cl. CPC F21V 7/00; F21V 19/02; F21V 17/04
USPC 362/217.05; 362/260; 362/263; 362/296.01; 362/298; 29/426.1; 29/428

(57) ABSTRACT

An integrated optic lamp assembly includes a rigid mounting structure, a base, a light source, and a reflector. The base, light source, and reflector are supported by the mounting structure. The base is configured to operationally connect to a light source socket. The reflector is configured and positioned relative to the light source to distribute light emitted from said light source in a predetermined light distribution pattern.

### CROSS-REFERENCE TO RELATED APPLICATION

This application claims priority under 35 U.S.C. § 119(e) from U.S. Provisional Patent Application Ser. No. 61/584,068 filed Jan. 6, 2012, the entirety of which is hereby incorporated by reference herein.

### BACKGROUND

In various lighting applications, it is desirable to distribute light from a light source according to a predetermined illumination pattern. The Illuminating Engineering Society of North America (IESNA) has designated several standard types of lighting fixtures (e.g., for roadway and area lighting applications) in terms of their light distribution patterns. For example, IESNA has specified illumination types I, II, III, IV, and V that are known to one of ordinary skill in the art. Details regarding these standard light distribution patterns are provided in FIG. 9. FIG. 9 shows the relationship of luminaire distribution to maximum area coverage. Maximum beam candlepower is indicated by the cross-hatched regions shown in FIG. 9.

A luminaire is a complete lighting unit that typically includes a light source (e.g., provided by a lamp), elements (e.g., optics) for controlling lighting and/or brightness, a housing (assembly), and auxiliary equipment such as a ballast or transformer. An optical element referred to as an optic modifies the pattern and/or direction of emitted light into a desired pattern or shape. In conventional lighting systems, the optic is part of a luminaire assembly, and the lamp is a separate component. For example, FIG. 1 A is an illustration of a conventional “cobra head” street lighting fixture (luminaire) 110. Luminaire 110 includes a luminaire assembly 120 having an optic (fixed reflector) 130. Referring to FIG. 1B, a lamp 140 is a separate component that can be attached (e.g., screwed) into a socket 150 of luminaire assembly 120. As another example, FIG. 2A is an illustration of a conventional area lighting fixture (luminaire) 210. Luminaire 210 includes a luminaire assembly 220 having an optic 230. Referring to FIG. 2B, a lamp 240 is a separate component that can be attached (e.g., screwed) into a socket 250 of luminaire assembly 220.

For roadway luminaires, the term “nadir” refers to the point on the ground directly below the light source. Luminaires that reduce luminous intensity (candlepower) in the portion of the light beam above the nadir (e.g., for reduced glare or for efficiency) are called full-cutoff, cutoff, or semi-cutoff luminaires based on the following classification. Full-cutoff luminaires provide 0% of total candlepower at 90° from nadir (i.e., horizontal) and no more than 10% of total candlepower at 80° from nadir. Cutoff luminaires provide no more than 2.5% of total candlepower at 90° from nadir, and no more than 10% of total candlepower at 80° from nadir. Semi-cutoff luminaires provide no more than 5% of total candlepower at 90° from nadir, and no more than 20% of total candlepower at 80° from nadir. A non-cutoff luminaire does not have such limitations in either zone (90° or 80° from nadir). Typically, a luminaire is fixed in terms of being full-cutoff, cutoff, or semi-cutoff.

### SUMMARY

In some embodiments, a method of relamping a luminaire is provided. The luminaire includes a housing enclosing a removable first light source and a fixed reflector. The first light source is removed from the housing. A removable integrated optic lamp assembly is installed into the housing. The integrated optic lamp assembly includes a second light source and an assembly reflector. The luminaire provides light in a standard light distribution pattern after installing the removable integrated optic lamp assembly.

In some embodiments, an integrated optic lamp assembly includes a rigid mounting structure, a base, a light source, and a reflector. The base, light source, and reflector are supported by the mounting structure. The base is configured to operationally connect to a light source socket. The reflector is configured and positioned relative to the light source to distribute light emitted from said light source in a predetermined light distribution pattern.

In some embodiments, an apparatus includes a reflector configured to be clamped to a socket of a luminaire and reflect light from a light source according to a standard light distribution pattern. The light source is within a bulb, and the reflector is configured to surround a portion of the bulb.

In some embodiments, a reflector is positioned to surround a portion of a bulb. The bulb is secured to a socket. The reflector is secured to the socket. The reflector is configured to reflect light from the bulb according to a standard light distribution pattern.

In some embodiments, a method of relamping a luminaire is provided. The luminaire comprises a housing enclosing a removable first light source and a fixed reflector, and the luminaire provides light in a standard light distribution pattern. A first socket, which is connected to the first light source, is removed from the luminaire. A second socket is installed in the luminaire. An integrated optic lamp assembly is secured to the second socket. The integrated optic lamp assembly comprises a second light source and an assembly reflector. The assembly reflector surrounds a portion of the second light source and is configured to reflect light from the second light source according to a standard light distribution pattern.

In some embodiments, a method is performed in a luminaire comprising a housing enclosing a light source and a first fixed reflector. A second reflector is positioned to reflect light from the light source. The second reflector is secured relative to the light source. The second reflector is configured to reflect light from the light source according to a standard light distribution pattern.

In some embodiments, a method of relamping is provided. A luminaire includes a socket, a first bulb connected to the socket, and a first reflector. The first bulb has a longitudinal axis of elongation and has a first maximum dimension in a direction perpendicular to the longitudinal axis. The first bulb is removed from the luminaire. A second bulb and a second reflector are installed in the luminaire. A second maximum dimension of the second bulb and the second reflector considered together in the installed position, in a direction perpendicular to the longitudinal axis, is less than or equal to the first maximum dimension.

In some embodiments, a luminaire encloses a space suitable for housing a first standard outer lamp jacket. The luminaire includes a first fixed reflector, a lamp socket, a second standard outer lamp jacket within said space and attached to the socket, a light source within the second standard outer lamp jacket, and a second reflector mounted within said space. The luminaire provides light in a standard light distribution pattern. The second standard outer lamp jacket and the second reflector together fit within said space.

In some embodiments, a method of relamping is provided. A luminaire includes a first bulb and a first fixed reflector. The first bulb is connected to a socket. The first bulb is removed from the socket. After the first bulb is removed, the luminaire defines a space available for installing another bulb. A second bulb and a second reflector are installed within the available space.

In some embodiments, a luminaire includes a housing defining a cavity, a fixed reflector, a light source, and a second reflector. The fixed reflector has a reflecting surface mounted within the cavity. The reflecting surface forms a partial boundary of an illumination space within the cavity. The light source is mounted within the illumination space. The second reflector is mounted within the illumination space, for reflecting light emitted from the light source in a desired light distribution pattern.

### BRIEF DESCRIPTION OF THE DRAWINGS

The following will be apparent from elements of the figures, which are provided for illustrative purposes and are not necessarily to scale.

FIGS. 1A-1B are illustrations of a conventional street lighting fixture.

FIGS. 2A-2B are illustrations of a conventional area lighting fixture.

FIGS. 3A-3B are illustrations, at different viewing angles, of a lamp with an integrated optic in accordance with some embodiments.

FIG. 4 is an illustration of an integrated optic lamp and street lighting luminaire in accordance with some embodiments.

FIG. 5 is an illustration of an integrated optic lamp and area lighting luminaire in accordance with some embodiments.

FIG. 6A is an illustration of a horizontally operated lamp with an integrated optic in accordance with some embodiments of the present disclosure.

FIG. 6B is an illustration of a vertically operated lamp with an integrated horizontal optic in accordance with some embodiments.

FIG. 6C is an illustration of a lamp with an adjustable base and an integrated optic in accordance with some embodiments.

FIG. 6D is an illustration of a vertically operated lamp with an integrated optic in accordance with some embodiments.

FIG. 6E is an illustration of a horizontally operated lamp with an integrated vertical optic in accordance with some embodiments.

FIG. 7 is an illustration of an in integrated optic lamp having an electrical connection provided by a cable and plug separate from the base in accordance with some embodiments.

FIG. 8 is an illustration of a lamp having an optic clamped to a socket in accordance with some embodiments.

FIG. 9 is an overview of some standard light distribution patterns.

### DETAILED DESCRIPTION

This description of the exemplary embodiments is intended to be read in connection with the accompanying drawings, which are to be considered part of the entire written description. In the description, relative terms such as “horizontal,” “vertical,” as well as derivatives thereof (e.g., “horizontally,” “vertically,” etc.) should be construed to refer to the orientation as then described or as shown in the drawing under discussion. These relative terms are for convenience of description and do not require that the apparatus be constructed or operated in a particular orientation.

Various embodiments of the present disclosure improve upon prior art lighting techniques by integrating an optic directly into the lamp assembly, to provide an integrated optic lamp. An integrated optic lamp enables retrofitting of existing light fixtures, e.g., “shoebox” fixtures commonly used in parking lot lighting applications (which may be used for 400 W metal halide lamps), and “cobra head” fixtures commonly used in street lighting applications (which may be used for, e.g., 150 W, 250 W, 400 W, or 1000 W lamps).

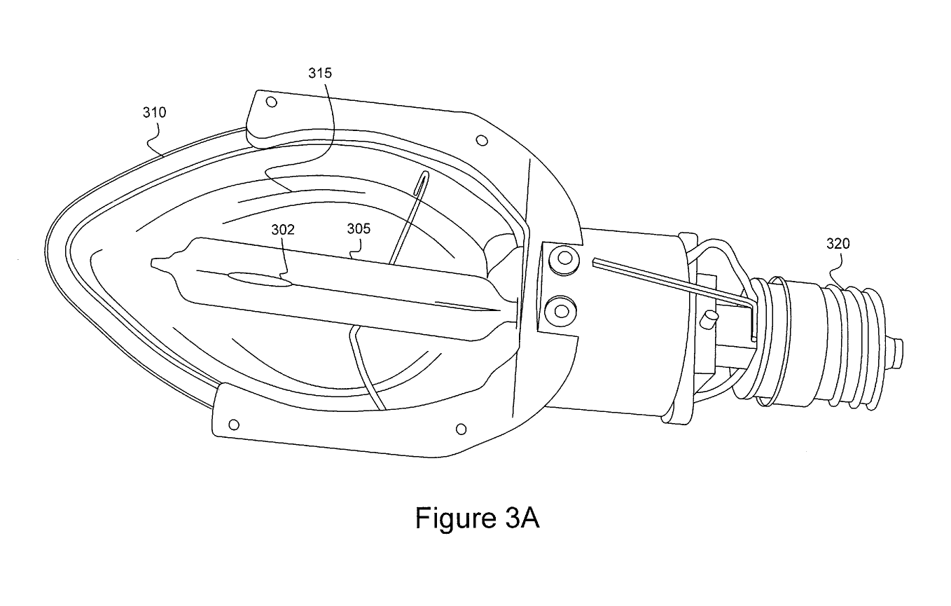

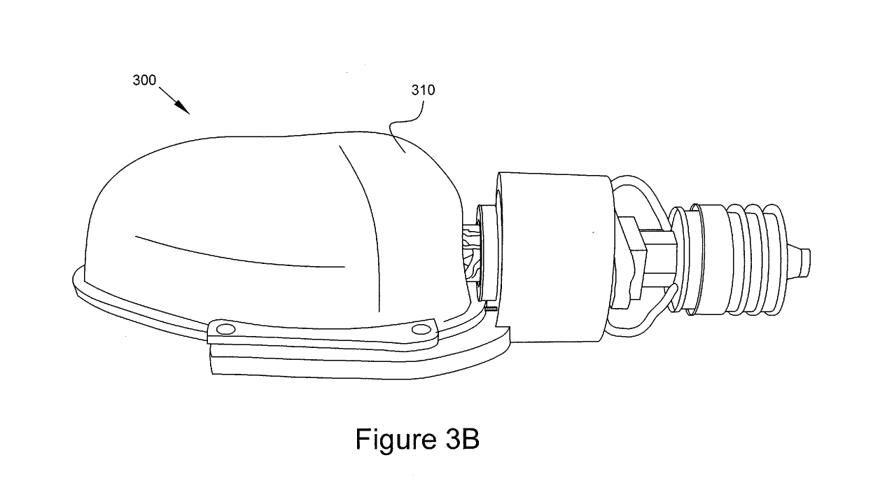

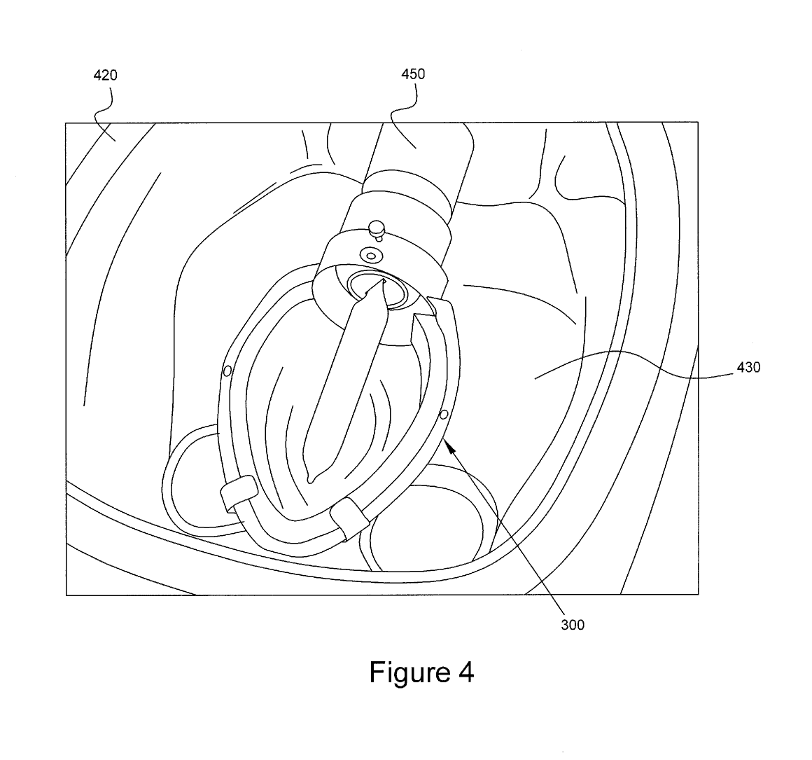

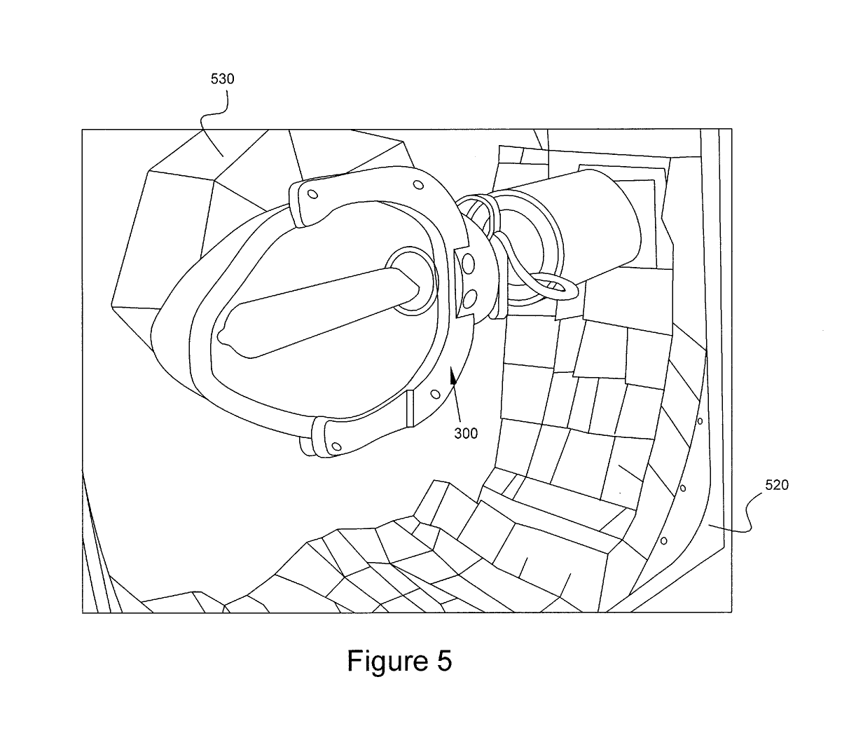

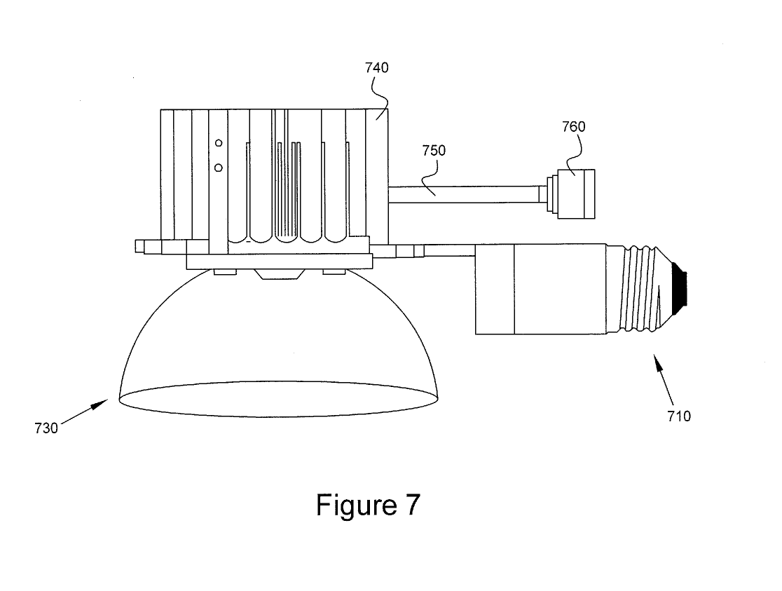

FIGS. 3A and 3B are illustrations, at different viewing angles, of a lamp with an integrated optic in accordance with some embodiments. Referring to FIG. 3A, a lamp 300 includes a light source 302 enclosed within a bulb 305, a mounting structure 310 to which the removable light source is attached, and a base 320 supported at one end of a rigid mounting structure, which may a stem or another structure to which other components may be attached. Various types of base may be used, including mogul type base, medium type base, bi-pin type base, double ended type contacts, any other multi-pin base, or twist-lock base. The base 320 is attached to the mounting structure 310 and is configured to operationally connect to a light source socket (socket not shown in FIG. 3A; shown in FIGS. 4-5). In some embodiments, the base 320 is configured to receive electrical power from the socket. In other embodiments, the base does not provide an electrical connection, and instead a cable separate from the base is used for that purpose, e.g., as shown in FIG. 7 which is described further below. The light source 302 is supported by the mounting structure and may be electrically connected to the base 320 or to an electric cable separate from the base.

An optic 315 (e.g., a reflector) is supported by and integrated with the mounting structure 310. Optic 315 is configured and positioned relative to the light source 302 to distribute light emitted from light source 302 in a predetermined light distribution pattern (e.g. any of the standard light distribution patterns specified as IESNA illumination types I, II, II, IV, V). Various light sources may be used with the integrated optic 315. For example, any of the following non-exhaustive list of lamps types may be used: incandescent; halogen; IR halogen; mercury; low pressure sodium; high pressure sodium; ultra high pressure mercury; metal halide; xenon; induction; fluorescent; compact fluorescent; light emitting diodes (LED); light emitting plasma (LEP). In the example of FIG. 3A, the light source 302 is elongated and has a longitudinal axis, and the reflector (optic) 315 is configured and positioned relative to the light source 302 to distribute light in a pattern substantially perpendicular to the longitudinal axis of the light source 302.

The integrated optic 315 is specially designed to match the light source 302 to achieve a desired distribution pattern, e.g., any of the IESNA type I, II, III, IV, and V patterns used for general commercial lighting, or any other desired distribution pattern. The integrated optic 315 may be manufactured according to known techniques for manufacturing an optic. For example, the optic may or may not have a multifaceted glass surface which may be coated with a chemical coating. The optic may be manufactured from a variety of materials including glass, various grades of aluminum, ceramic, plastic, other metals or reflective surfaces. In addition to enabling a desired distribution type, a desired luminous intensity (e.g., minimum number of foot-candles) may be achieved with the specially designed integrated optic 315. Providing an integrated optic lamp 300 also enables increased efficiency. For example, in some embodiments, wattage of 150 W-200 W for an integrated optic lamp provides as much light output (intensity) as 400 W provides for a conventional lamp in which the optic is conventionally part of a luminaire assembly that is separate from the lamp. In some embodiments, provision of the same light intensity while using a lower wattage bulb is made possible because the integrated optic 315 is designed for a specific, relatively narrow, range of wattages, e.g., corresponding to a specific bulb, whereas in conventional luminaires the conventional fixed reflector (optic) is required to accommodate a relatively wide range of wattages.

FIG. 3B is an illustration of lamp 300 from another view. Light emanating from the light source is controlled by the optic that is integrated with the mounting structure 310. If lamp 300 is installed in a fixture that contains its own optic, the optic 315 integrated with mounting structure 310 may control the light distribution so that little or no light reaches the optic of the fixture.

FIG. 4 is an illustration of an integrated optic lamp and street lighting luminaire in accordance with some embodiments. A luminaire assembly 420 has an optic 430 integrated therewith. Integrated optic lamp 300 can be mounted in (e.g., screwed into) a socket 450 of luminaire assembly 420. Optic 315 which is integrated into lamp 300 (see FIG. 3A) controls the light distribution pattern, e.g., so that little or no light reaches optic 430 of luminaire assembly 420. Optic 315 is positioned so that the light source is nearer to optic 315 than to the fixed optic 430 of the luminaire assembly.

Similarly, FIG. 5 is an illustration of integrated optic lamp installed in an area lighting luminaire in accordance with some embodiments. Although luminaire assembly 520 has an optic 530, lamp 300 has its own integrated optic that controls the light distribution pattern, so that little or no light reaches optic 530.

Thus, integrated optic lamp 300 may be mounted in existing luminaires and may be used to change the light distribution pattern of an existing luminaire This has not been possible previously with conventional luminaires in which a lamp is separate from an optic having a given light distribution pattern. Because a lamp in accordance with various embodiments has an integrated optic, replacement of the integrated optic lamp can coincide with modification of the light distribution pattern, e.g., to accommodate changing lighting requirements.

Embodiments of the present disclosure allow the optic to be placed in any spatial configuration independent of the light source. Existing luminaires of various types (e.g., mogul fixtures) may be retrofitted with integrated optic lamps without changing the existing optic (e.g., fixed reflector) within the housing (luminaire assembly) and may be functional in a standard single or double ended lamp housing. Such retrofitting promotes efficiency (e.g., reduced wattage to provide a given light output, as described above) and reduced cost (e.g., in terms of energy costs and maintenance/upgrade costs). Relamping may include removing a light source from an existing socket and installing an integrated optic lamp assembly into that socket. Alternatively, relamping may include removing the existing socket (and light source connected thereto) itself and installing an integrated optic lamp assembly, which includes a different socket, into the housing.

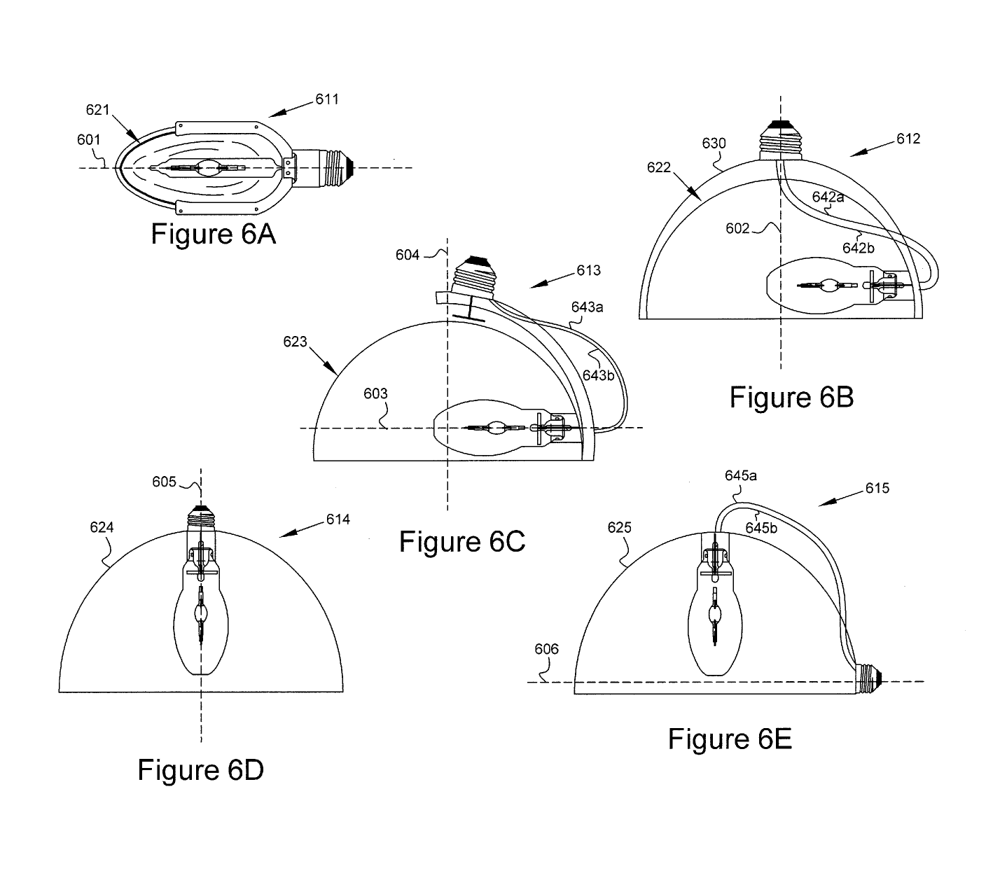

For example, FIGS. 6A-6E show various configurations for retrofitting an integrated lamp. Optics (e.g., reflectors) 621, 622, 623, 624, and 625 are integrated into lamps 611, 612, 613, 614, and 615, respectively. A luminaire may be relamped by removing an existing light source from the housing (luminaire assembly) and installing into the housing a removable integrated optic lamp assembly that includes a light source and an assembly reflector (integrated optic). After installing the removable integrated optic lamp assembly, the relamped luminaire may provide light in a standard light distribution pattern, which may be different than the light distribution pattern previously provided (before relamping) by a fixed reflector enclosed by the housing. The rated wattage of the light source in the removable integrated optic lamp assembly may be less than the rated wattage of the light source that was removed from the luminaire and yet still provide the required light intensity (e.g., required number of foot-candles).

An integrated optic lamp may be retrofitted into an existing horizontal lamp socket, e.g., in the cases of FIGS. 6A and 6E where the installation axes 601, 606 (along which the lamp is installed into a socket) of lamps 611 and 615 in FIGS. 6A and 6E, respectively, are situated parallel (or approximately parallel) to the ground. Lamps 611 and 615 may be referred to as horizontally operated lamps.

Alternatively, an integrated optic lamp may be retrofitted into an existing vertical lamp socket, e.g., in the cases of FIGS. 6B and 6D where the respective installation axes 602, 605 are perpendicular (or approximately perpendicular) to the ground. Lamps 612 and 614 may be referred to as vertically operated lamps. In FIG. 6B, the longitudinal axis of the light source is oriented horizontally, and the optic distributes the light emitted from the light source substantially downward. In FIG. 6B, an optic assembly support structure 630 may provide mechanical orientation. Support structure 630 may formed from metal, plastic, or various other materials. In FIG. 6D, the light source is elongated and has a longitudinal axis, and the optic is configured and positioned relative to the light source to distribute light in a pattern substantially parallel to the longitudinal axis of the light source.

Wires 642a, 642b may electrically couple the light source and the base; similar wires are shown as wires 643a, 643b in FIG. 6C and as wires 645a, 645b in FIG. 6E.

A horizontally oriented light source may be integrated with a vertically operated lamp, e.g., as in FIG. 6B, where installation axis 602 is perpendicular or nearly perpendicular to the ground). Alternatively, a vertically oriented light source may be integrated with a horizontally operated lamp, e.g., as in FIG. 6E, where installation axis 606 is parallel or nearly parallel to the ground.

In some embodiments, the light source is spherical. Alternatively, the light source may be hemispherical or have an oblong shape in the case of a light emitting diode (LED) or light emitting plasma (LEP). The LED or LEP light source may be positioned at the apex of an optic as in FIG. 7 and does not need to be positioned within the optic.

In some embodiments, electrical power is conveyed to the light source not through the base but rather through an electrical cable that is external to the base. FIG. 7 shows a lamp with a base 710, a light source 720 , and an integrated optic (reflector) 730. The base 710 is configured for attachment to a socket to provide mechanical support. The light source 720 is positioned at the apex of the optic in this configuration. Cooling fins may be used due to high temperatures associated with operation of the light source 720. A cable 750 and plug 760 are used to supply electrical power to the light source 720, e.g., with the plug 760 providing a connection to a power supply.

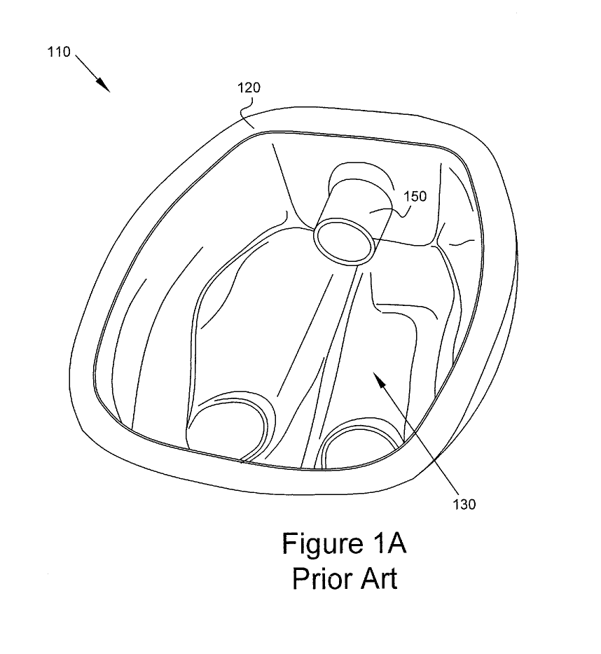

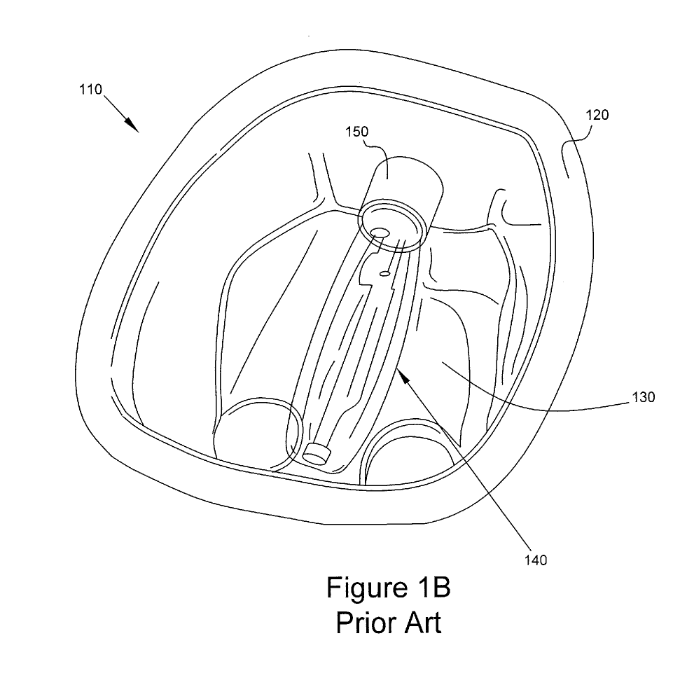

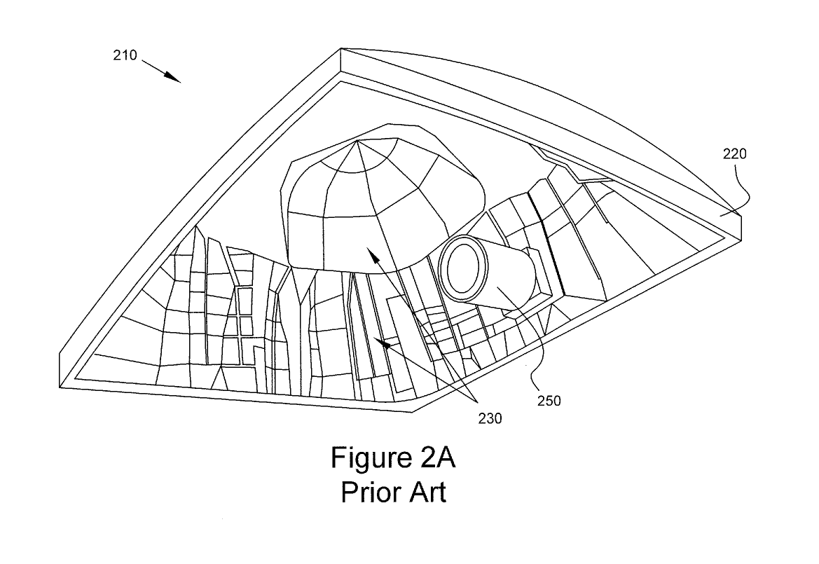

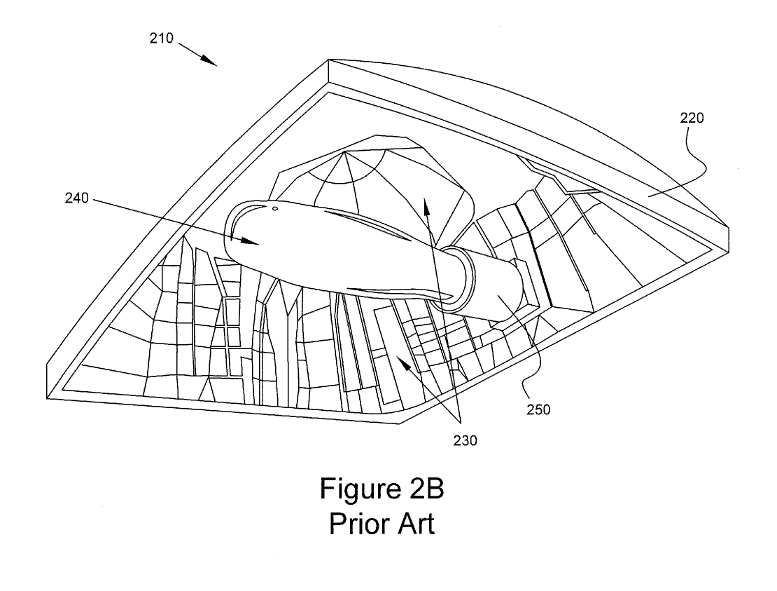

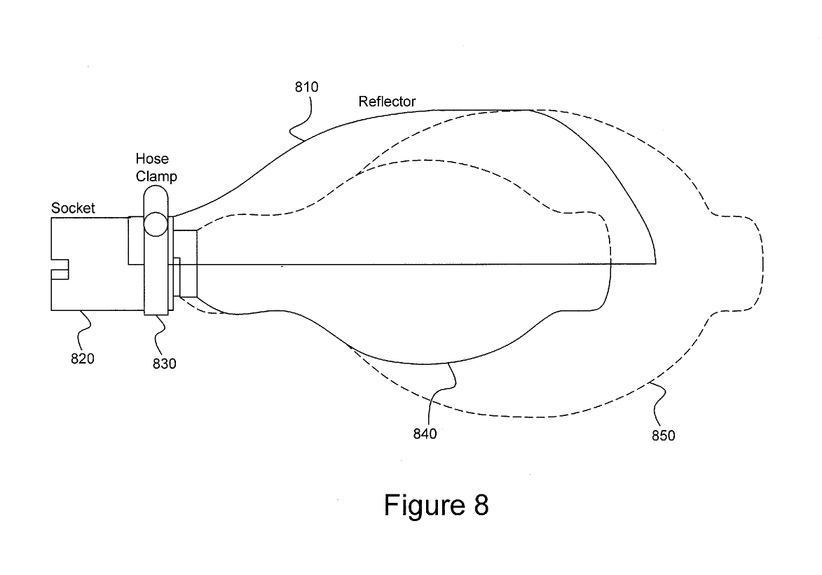

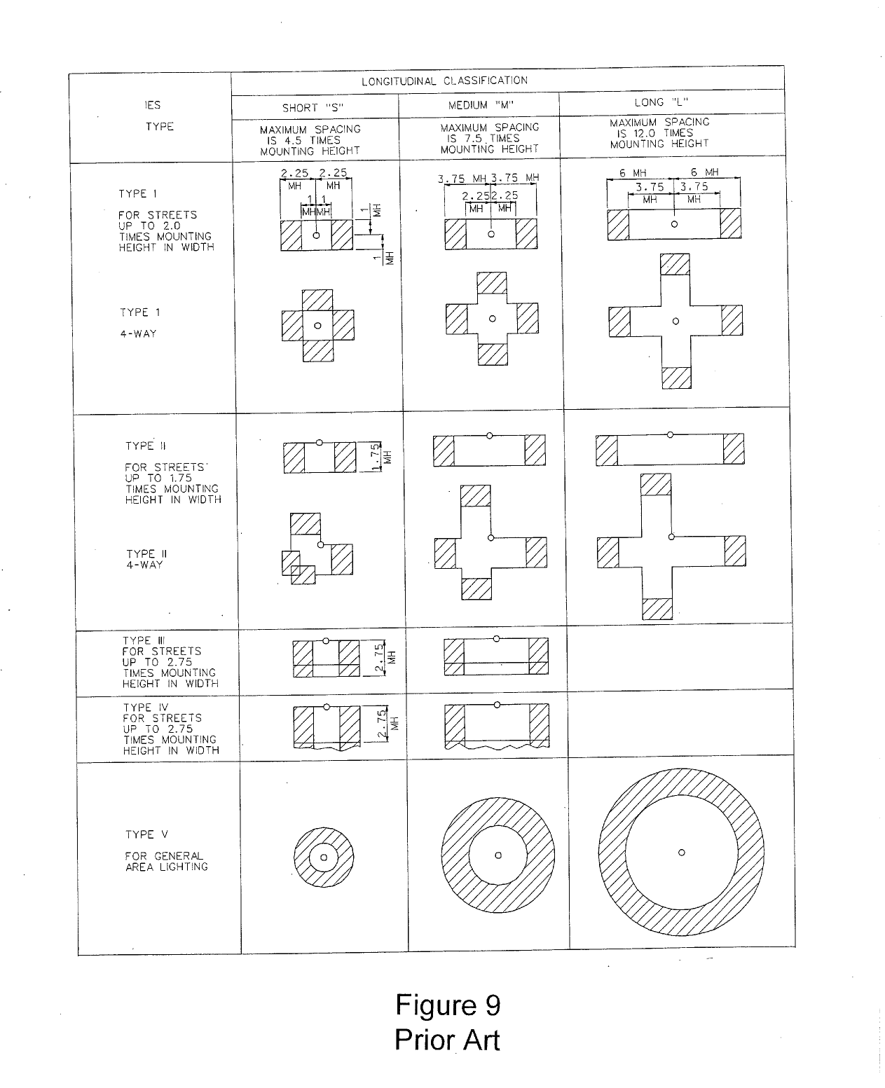

FIG. 8 is an illustration of a lamp having an optic (reflector) 810 clamped to a socket 820 in accordance with some embodiments. A light source may be within a bulb 840, which may be a standard outer jacket such as a BT37 bulb. The light source may be any of various types of light source, e.g., a metal halide arc tube. The bulb 840 is connected to a socket 820 of a luminaire housing, which may have a separate fixed reflector (not shown in FIG. 8; see, e.g., optic 130 of FIG. 1 or optic 230 of FIG. 2). Optic 810 is placed as shown in FIG. 8 and secured relative to the light source, e.g., by securing the optic to the socket 820, to the bulb 810, or to a frame which may be attached to the bulb, socket, or another part of the luminaire housing. A clamp 830 (e.g., hose clamp) may be used to secure the optic 810. The optic 810 is positioned so that the light source is closer to optic 810 than to the separate fixed reflector of the housing. The optic 810 reflects light from the light source according to a standard light distribution pattern. The separate fixed reflector of the luminaire housing may also reflect light according to a standard light distribution pattern, which may be the same as or different from the distribution pattern corresponding to optic 810. Regardless of the type or configuration of the existing fixed reflector(s) within the luminaire, the integrated optic lamp is conveniently configured to meet various lighting requirements by using optic 810.

In some embodiments, reflector 810 may be used to support relamping. For example, a light source may be within a bulb 850 (an outline of which is shown in FIG. 8), which may be a standard outer jacket such as a BT56 bulb. Bulb 850 may be removed from socket 820, which may be part of a luminaire housing and/or may be removable from the luminaire housing. The luminaire housing may have a fixed reflector different from reflector 810. A smaller bulb such as bulb 840 may be installed into the socket. Optic 810 may be secured in place relative to the light source as described above.

Alternatively, the existing bulb 850 may originally be connected to a first socket, and that existing first socket may be removed from the luminaire housing (e.g., without removing the bulb 850 from the first socket), and a new socket 820 may be installed, e.g., with the new socket 820 already having bulb 840 attached thereto and with reflector 810 secured in place relative to the new light source. Changing the first socket (which has bulb 850 connected thereto) in the field without removing bulb 850 from the first socket may reduce maintenance costs. Also, using optic 810 may reduce maintenance costs, as the lamp can be retrofitted (e.g., to change the light distribution pattern) without having to change the existing fixed reflector(s) of the luminaire housing.

In some embodiments, the new bulb 840 is smaller (has lower volume) and has lower wattage than the old bulb 850 and yet provides the same light intensity, e.g., due to increased efficiency provided by optic 810 relative to the existing fixed reflector. Reflector 810 may be dimensioned so that when secured relative to the light source, the reflector fits in the same three-dimensional footprint as the old bulb 850. For example, in FIG. 8, the top of optic 810 is shown coincident with the top of bulb 850. As the bottom of optic 810 is coincident with the central axis of bulb 850, in this example the maximum height of optic 810 is half the maximum height of bulb 850.

The components shown in FIG. 8 may be within a luminaire, e.g., as in FIGS. 4-5. The luminaire may have a first fixed reflector. The luminaire may be relamped to replace a first bulb (e.g., bulb 850) with a second bulb (e.g., bulb 840). Bulb 850 has a longitudinal axis of elongation (in the view of FIG, the longitudinal axis is horizontal). Bulb has a first maximum dimension in a direction perpendicular to the longitudinal axis (i.e., a maximum vertical extent in the view of FIG. 8). Relamping may be accomplished as follows. Bulb 850 is removed from the luminaire. Bulb 840 and reflector 810 are installed in the luminaire. Reflector 810 may be secured to the socket or to bulb 840 in some embodiments. A second maximum dimension of bulb 840 and reflector 810 considered together (i.e., the bulb-reflector combination), in a direction perpendicular to the longitudinal axis, is less than or equal to the first maximum dimension. This ensures that bulb 840 and reflector 810 can fit in the footprint formerly occupied by bulb 850 within the luminaire. In the example shown in FIG. 8, the maximum dimension of reflector 810 perpendicular to the longitudinal axis is one-half the first maximum dimension, In some embodiments, socket 820 (e.g., with the first bulb connected thereto) is first removed from the luminaire and then another socket (e.g., with the second bulb and/or reflector 810 connected thereto) is installed in the luminaire.

In some embodiments, bulb 850 is removed from socket 820, and after this removal, the luminaire defines a space available for installing another bulb. Then, bulb 840 and reflector 810 are installed within the available space.

In some embodiments, a luminaire includes a housing defining a cavity, a fixed reflector (e.g., reflector 430 or 530), a light source (e.g., light source 302), and a second reflector (e.g., reflector 810). The first fixed reflector has a reflecting surface mounted within the cavity. The reflecting surface forms a partial boundary of an illumination space within the cavity. The light source is mounted within the illumination space. The second reflector is mounted within the illumination space. The second reflector is for reflecting light emitted from the light source in a desired light distribution pattern, e.g., a standard light distribution pattern. The illumination space may be dimensioned to house a light source having a first standard outer lamp jacket with no second reflector mounted within the space. The illumination space may be dimensioned to house a light source having a second standard outer lamp jacket and the second reflector.

Thus, various embodiments provide flexibility regarding the use of a lamp having an integrated optic in various spatial configurations. In addition, an integrated optic lamp 613 may have an adjustable base, as in FIG. 6C, where the lamp may be installed into a socket in various orientations ranging from along axis 604 to along axis 603. The adjustable base allows a vertical lamp to be used in a horizontal orientated fixture or a horizontal lamp to be used in a vertical fixture. The adjustable base accommodates operation at various angles.

Furthermore, an integrated optic lamp may change an existing luminaire of the non-cutoff, semi-cutoff, or cutoff types into a full-cutoff luminaire, thereby providing flexibility that has not been possible before with an optic fixed to a luminaire assembly separate from the lamp.

Unlike conventional approaches, the optic in an integrated optic lamp may be adjusted independently of the light source, so that the optic may be oriented horizontally, vertically, or at an angle with respect to the axis of the light source. Furthermore, the light source can be rotated around its axis independent of the optic, thereby enabling installation of the integrated optic lamp inside luminaries with limited space which would inhibit rotational movement.

Although examples are illustrated and described herein, embodiments are nevertheless not limited to the details shown, since various modifications and structural changes may be made therein by those of ordinary skill within the scope and range of equivalents of the claims.

What is claimed is:

1. In a luminaire comprising a housing enclosing a removable first light source and a fixed reflector wherein the luminaire provides light in a standard light distribution pattern, a method of relamping the luminaire comprising the steps:
removing the first light source from the housing; and
installing a removable integrated optic lamp assembly into the housing, said integrated optic lamp assembly comprising a second light source and an assembly reflector,
wherein the luminaire provides light in a standard light distribution pattern after installing the removable integrated optic lamp assembly.

2. The method of claim 1 wherein the position of the fixed reflector is maintained within the housing.

3. The method of claim 1 wherein the removable integrated optic lamp assembly comprises a mogul base.

4. The method of claim 1 wherein the second light source in the removable integrated lamp assembly is selected from the group consisting of incandescent, halogen, IR halogen, mercury, low pressure sodium, high pressure sodium, ultra high pressure mercury, metal halide, xenon, induction, compact fluorescent, light emitting diodes (LED), light emitting plasma (LEP), and fluorescent light sources.

5. The method of claim 4 wherein the second light source in the removable integrated optic lamp assembly comprises a metal halide light source.

6. The method of claim 1 wherein the luminaire comprises a lamp socket oriented horizontally for receiving a light source.

7. The method of claim 1 wherein the luminaire comprises a lamp socket oriented vertically for receiving a light source.

8. The method of claim 1 wherein the rated wattage of the second light source in the removable integrated optic lamp assembly is less than the rated wattage of the first light source removed from the luminaire.

9. The method of claim 1 wherein the luminaire provides light in a first standard light distribution pattern after installing the removable integrated optic lamp assembly, and the luminaire provided light in a second standard light distribution pattern before installing the removable integrated optic lamp assembly.

10. The method of claim 1 wherein the step of removing the first light source from the housing includes removing the light source from a socket, and the step of installing the removable integrated optic lamp assembly into the housing includes installing the integrated optic lamp assembly into said socket.

11. The method of claim 1 wherein the step of removing the first light source from the housing includes removing a first socket from the housing, and the step of installing the removable integrated optic lamp assembly into the housing includes installing the integrated optic lamp assembly including a second socket into the housing.

12. An integrated optic lamp assembly comprising:
a rigid mounting structure;
a base supported by said mounting structure, said base being configured to operationally connect to a light source socket;
a light source supported by said mounting structure; and
a reflector supported by said mounting structure, said reflector being configured and positioned relative to said light source to distribute light emitted from said light source in a predetermined light distribution pattern.

13. The integrated optic lamp assembly of claim 12 wherein said reflector is configured and positioned relative to said light source to distribute light emitted from said light source in a standard light distribution pattern.

14. The integrated optic lamp assembly of claim 12 wherein said base is a mogul type base, medium type base, bi-pin type base, double ended type contacts, multi-pin base, or twist-lock base.

15. The integrated optic lamp assembly of claim 12 wherein said light source is elongated having a longitudinal axis and said reflector is configured and positioned relative to said light source to distribute light in a pattern substantially perpendicular to the longitudinal axis of said light source.

16. The integrated optic lamp assembly of claim 15 wherein the longitudinal axis of said light source is oriented horizontally and said reflector distributes the light emitted from said source substantially downward.

17. The integrated optic lamp assembly of claim 15 wherein said light source is positioned at an apex of said reflector.

18. The integrated optic lamp assembly of claim 12 wherein said light source is elongated having a longitudinal axis and said reflector is configured and positioned relative to said light source to distribute light in a pattern substantially parallel to the longitudinal axis of said light source.

19. The integrated optic lamp assembly of claim 12 wherein said light source is selected from the group consisting of incandescent, halogen, IR halogen, mercury, low pressure sodium, high pressure sodium, ultra high pressure mercury, metal halide, xenon, induction, compact fluorescent, light emitting diodes (LED), light emitting plasma (LEP), and fluorescent light sources.

20. The integrated optic lamp assembly of claim 19 wherein said light source is a metal halide light source.

21. An apparatus comprising a reflector configured to be clamped to a socket of a luminaire and reflect light from a light source according to a standard light distribution pattern, wherein the light source is within a bulb and the reflector is configured to surround a portion of the bulb.

22. The apparatus of claim 21, further comprising a clamp configured to secure said reflector to said socket

23. A method comprising:
positioning a reflector to surround a portion of a bulb, wherein the bulb is secured to a socket; and
securing the reflector to the socket;
wherein the reflector is configured to reflect light from the bulb according to a standard light distribution pattern.

24. The method of claim 23, wherein securing the reflector to the socket includes clamping the reflector to the socket.

25. In a luminaire comprising a housing enclosing a removable first light source and a fixed reflector wherein the luminaire provides light in a standard light distribution pattern, a method of relamping the luminaire comprising the steps:
removing a first socket from the luminaire, wherein the first socket is connected to the first light source; and
installing a second socket in the luminaire, wherein an integrated optic lamp assembly is secured to the second socket, said integrated optic lamp assembly comprising a second light source and an assembly reflector, wherein the assembly reflector surrounds a portion of the second light source and is configured to reflect light from the second light source according to a standard light distribution pattern.

26. In a luminaire comprising a housing enclosing a light source and a first fixed reflector, a method comprising the steps:
positioning a second reflector to reflect light from the light source; and
securing the second reflector relative to the light source;
wherein the second reflector is configured to reflect light from the light source according to a first standard light distribution pattern.

27. The method of claim 26, wherein prior to said positioning and said securing, the first reflector is configured to reflect light from the light source according to a second standard light distribution pattern.

28. The method of claim 26, wherein said positioning includes positioning the second reflector to surround a portion of a bulb enclosing the light source.

29. The method of claim 26, wherein the second reflector is secured to a socket of the housing.

30. The method of claim 29, wherein the second reflector is secured to the socket using a clamp.

31. The method of claim 26, wherein the second reflector is secured to a bulb enclosing the light source.

32. The method of claim 26, wherein the light source is closer to the second reflector than to the first reflector.

33. In a luminaire including a socket, a first bulb connected to the socket, and a first reflector, the first bulb having a longitudinal axis of elongation, the first bulb having a first maximum dimension in a direction perpendicular to the longitudinal axis, a method of relamping comprising:
removing the first bulb from the luminaire; and
installing a second bulb and a second reflector in the luminaire;
wherein a second maximum dimension of the second bulb and the second reflector considered together in the installed position, in a direction perpendicular to the longitudinal axis, is less than or equal to the first maximum dimension.

34. The method of claim 33, wherein the second bulb has a smaller volume than the first bulb.

35. The method of claim 33, wherein the maximum dimension of the second reflector perpendicular to the longitudinal axis is less than or equal to one-half the first maximum dimension.

36. The method of claim 33, wherein the second reflector is secured to the socket.

37. The method of claim 33, wherein the second reflector is secured to the second bulb.

38. The method of claim 33, wherein the first socket is removed from the luminaire and a second socket is installed in the luminaire.

39. A luminaire enclosing a space suitable for housing a first standard outer lamp jacket, the luminaire comprising:
a first fixed reflector;
a lamp socket;
a second standard outer lamp jacket within said space and attached to said socket;
a light source within said second standard outer lamp jacket; and
a second reflector mounted within said space;
wherein the luminaire provides light in a standard light distribution pattern, and said second standard outer lamp jacket and said second reflector together fit within said space.

40. The luminaire of claim 39, wherein said first standard outer lamp jacket is a BT56 outer lamp jacket.

41. The luminaire of claim 39, wherein said second standard outer lamp jacket is a BT37 outer lamp jacket.

42. The luminaire of claim 39, wherein said second reflector has a maximum height no more than half the maximum height of the first standard outer lamp jacket.

43. In a luminaire including a first bulb and a first fixed reflector, the first bulb connected to a socket, a method of relamping comprising:
removing the first bulb from the socket, wherein after the first bulb is removed the luminaire defines a space available for installing another bulb; and
installing a second bulb and a second reflector within the available space.

44. The method of claim 43, wherein the first bulb includes a BT56 outer lamp jacket and the second bulb includes a BT37 outer lamp jacket.

45. A luminaire comprising:
a housing defining a cavity;
a first fixed reflector having a reflecting surface mounted within said cavity, said reflecting surface forming a partial boundary of an illumination space within said cavity;
a light source mounted within said illumination space; and
a second reflector mounted within said illumination space; said second reflector for reflecting light emitted from said light source in a desired light distribution pattern.

46. The luminaire of claim 45 wherein said illumination space is dimensioned to house a light source having a first standard outer lamp jacket with no second reflector mounted within said space.

47. The luminaire of claim 46 wherein said illumination space is dimensioned to house a light source having a second standard outer lamp jacket and said second reflector.
